(19) United States
(12) Patent Application Publication
(10) Pub. No.: US 2008/0292394 A1
(43) Pub. Date: Nov. 27, 2008

(54) Tube rack connector

(76) Inventor: Chou-Lian Yang, Taichung (TW)

Correspondence Address: BIRCH STEWART KOLASCH & BIRCH, PO BOX 747, FALLS CHURCH, VA, 22040-0747, US

(21) Appl. No.: 11/802,701

(22) Filed: May 24, 2007

(51) Int. Cl. F16B 7/00

(52) U.S. Cl. 403/344; 403/234

(57) ABSTRACT

A tube rack connector includes a lid and a carrier incorporated to each other, multiple slots and secondary slots being disposed on one side each of the lid and the carrier to receive an elastic member; and multiple fasteners each inserting through a locating hole and a connecting hole respectively from the lid and the carrier to allow a stud from a tube to fast and directly insert into the limiting hole to secure the tube in the groove without slip and deflection and convenient replacement of a tube by loosening up without removing the fasteners since both of the lid and carrier are held open due to elasticity exerted from the elastic member.

### FIELD OF THE INVENTION

The present invention is related to a connector, and more particularly, to a tube rack connector that allows easy and fast assembly and disassembly of the tube rack.

### BACKGROUND OF THE INVENTION

Whereas a connector is needed in a tubing operation and connectors generally available in the market are related to an integrated part molded by injection for cost reduction, sizes of groove and bore designed for the connector are fixed. Tubes with smooth surface to be assembled into a tube rack are vulnerable to deflect and slide in the groove. To correct this flaw, a stud is disposed on the surface of the tube and a dent is provided on the groove of the connector to engage the stud when the tube is inserted into the connector. Therefore, the connector has to be made in separate parts in conjunction with screw and nut to tighten up or loosen up in mounting or removing the tube to or from the connector.

### SUMMARY OF THE INVENTION

The primary purpose of the present invention is to provide an improved construction of a connector used in fabrication of a tube rack to allow easy and fast mounting or removing of a tube to or from the connector.

To achieve the purpose, a connector of the present invention is comprised of a lid and a carrier incorporated to each other with a fastener; on one side each of the lid and the carrier is disposed with a groove and a secondary groove to accommodate insertion of an elastic member; the fastener is inserted through a locating hole and a connecting hole; elasticity exerted by the elastic member allows the lid and the carrier to be appropriately held open to introduce a stud from a tube to fast and directly insert into limiting holes disposed on lateral and longitudinal grooves and/or secondary lateral and longitudinal grooves for the tube to be automatically secured in position in the connector without slip or deflection; and the tube can be conveniently removed simply by loosening up the fastener.

### BRIEF DESCRIPTION OF THE DRAWINGS

FIG. 1 is an exploded view of a first preferred embodiment of the present invention.

FIG. 2 is an exploded view of a second preferred embodiment of the present invention.

FIG. 3 is an exploded view of a third preferred embodiment of the present invention.

FIG. 4 is an exploded view of a fourth preferred embodiment of the present invention.

FIG. 5 is an exploded view of a fifth preferred embodiment of the present invention.

FIG. 6 is an exploded view of a sixth preferred embodiment of the present invention.

FIG. 7 is an exploded view of a tube in the present invention.

FIG. 8 is an exploded view of another tube in the present invention.

FIG. 9 is an exploded view of a seventh preferred embodiment of the present invention.

FIG. 10 is an exploded view of an eighth preferred embodiment of the present invention.

FIG. 11 is an exploded view of a ninth preferred embodiment of the present invention.

FIG. 12 is an exploded view of a tenth preferred embodiment of the present invention.

### DETAILED DESCRIPTION OF THE PREFERRED EMBODIMENTS

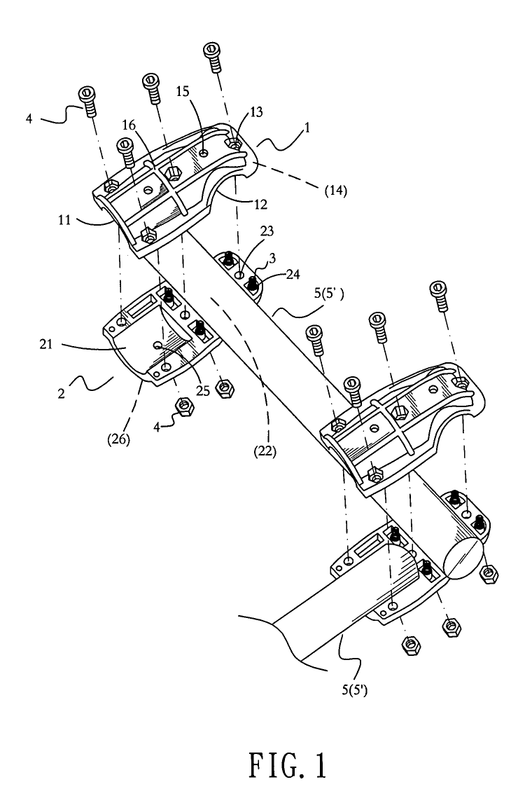

Referring to FIG. 1, a first preferred embodiment of the present invention includes a lid (1), a carrier (2), multiple elastic members (3), and multiple fasteners (4). The lid (1) has on one side provided with a longitudinal groove (11) and a lateral groove (12) disposed on one end of the longitudinal groove (11); a locating hole (13) is each disposed on both sides of the longitudinal groove (11), and at where between one end of the lateral groove (12) and the longitudinal and lateral grooves (11) (12) respectively; a slot (14) disposed by each locating hole (13) corresponds to each secondary slot (24) to be described below.

The carrier (2) incorporated to the lid (1) has on one side disposed with a secondary longitudinal groove (21) and a secondary laterally groove (22) corresponding to those longitudinal and lateral grooves (11) (12), and multiple connecting holes (23) corresponding to those locating holes (13) of the lid (1) with each connecting hole (23) provided next to it a secondary slot (24) corresponding to the slot (14) of the lid (1). Multiple reinforcement ribs (16) (26) are disposed on the other side of each of the lid (1) and the carrier (2) to reinforce the structure and dissipate stress resulted from the assembly of the lid (1) and the carrier (2). The secondary lateral slot (22) and the lateral slot (12) are provided in relation to each other. Those multiple elastic members (3) are received in the slots (14) and secondary slots (24). Those fasteners (4) are disposed in those locating holes (13) and connecting holes (23) respectively disposed on the lid (1) and the carrier (2).

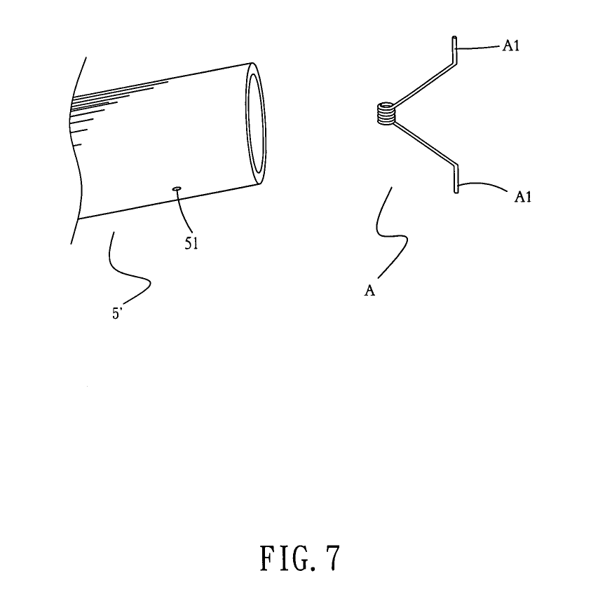

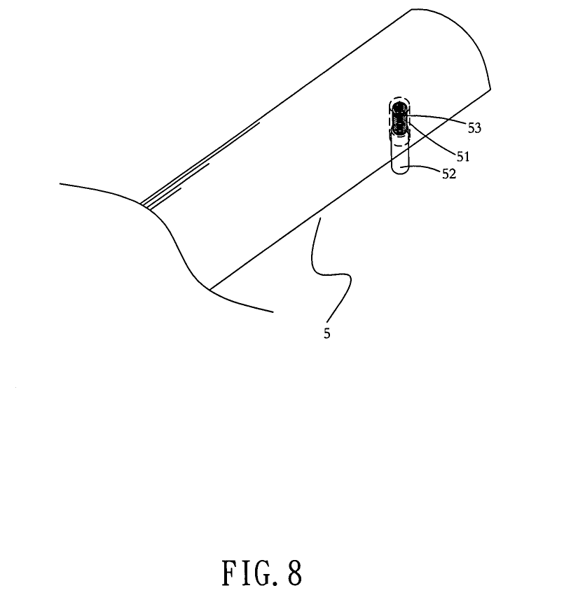

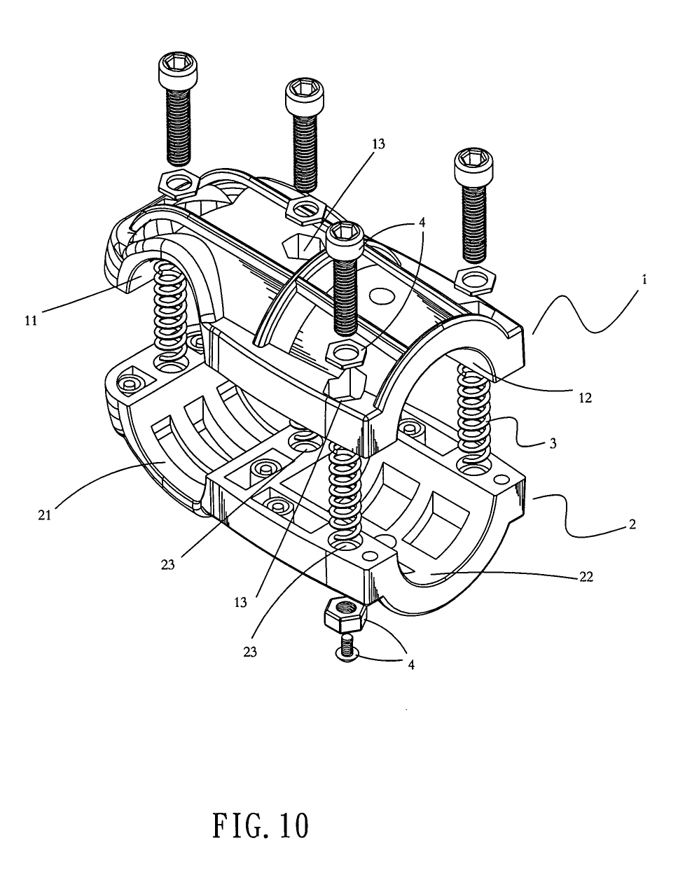

Accordingly, assuming that the connector of the first preferred embodiment of the present invention as illustrated in FIG. 1 has been assembled and a tube (5) as illustrated in FIG. 7 or a hollow tube (5′) as illustrated in FIG. 8 is ready for inserting into the connector, it takes only to loosen up those fasteners (4) without necessarily removing them to insert the tube (5, 5′) into the connector since those elastic members (3) pivoted to their respective slots (14) of the lid (1) will raise the lid (1) to a certain extent for mounting or replacing the tube (5, 5′) and those elastic members (3) extend and hold against their respectively secondary slots (24) due to that those slots (14) are disposed in relation to those secondary slots (24) on the carrier (2). On the contrary, simply tighten up those fasteners (4) using a hand tool for the lid (1) and the carrier (2) to incorporate to each other once again. Meanwhile the lid (1) compresses those elastic members (3) into a packed status for the tube (5, 5′) to be firmly secured in those longitudinal and lateral grooves (11) (12) and/or those secondary longitudinal and secondary lateral grooves (21) (22) without slip or deflection. In the first preferred embodiment, the construction of the slot (14) is the same as that of the secondary slot (24); the construction of the secondary lateral grooves (22) is same as that of the groove (22) illustrated in FIG. 10; and the construction of the reinforcement rib (26) is the same as that of the reinforcement rib (16).

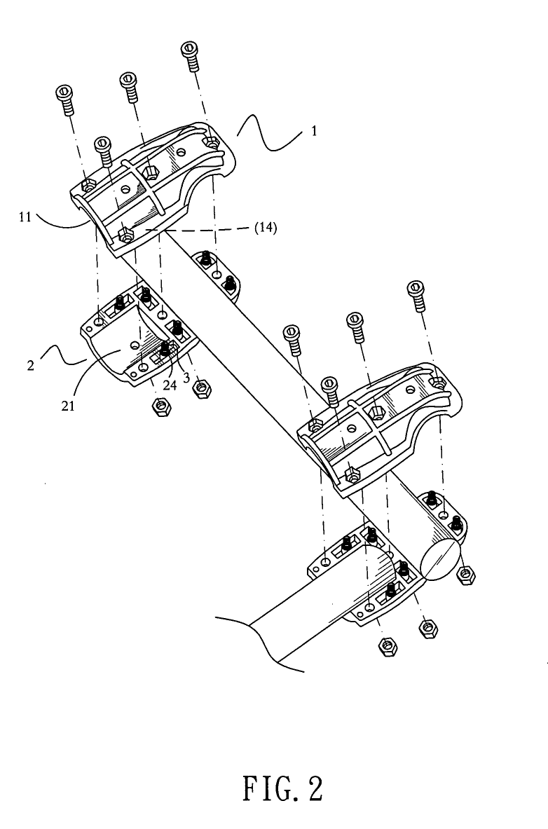

Now referring to a second preferred embodiment of the present invention as illustrated in FIG. 2, multiple secondary slots (24) are respectively provided on both sides of the secondary longitudinal groove (21) with each secondary slot (24) mounted with the elastic member (3); similarly, corresponding multiple slots (14) each also mounted with the elastic member (3) in same construction as that of those secondary slots (24) are respectively on both sides of the longitudinal groove (11) to achieve the same purpose as and stronger elasticity to hold open the lid (1) and the carrier (2) than that achieved and provided by the first preferred embodiment.

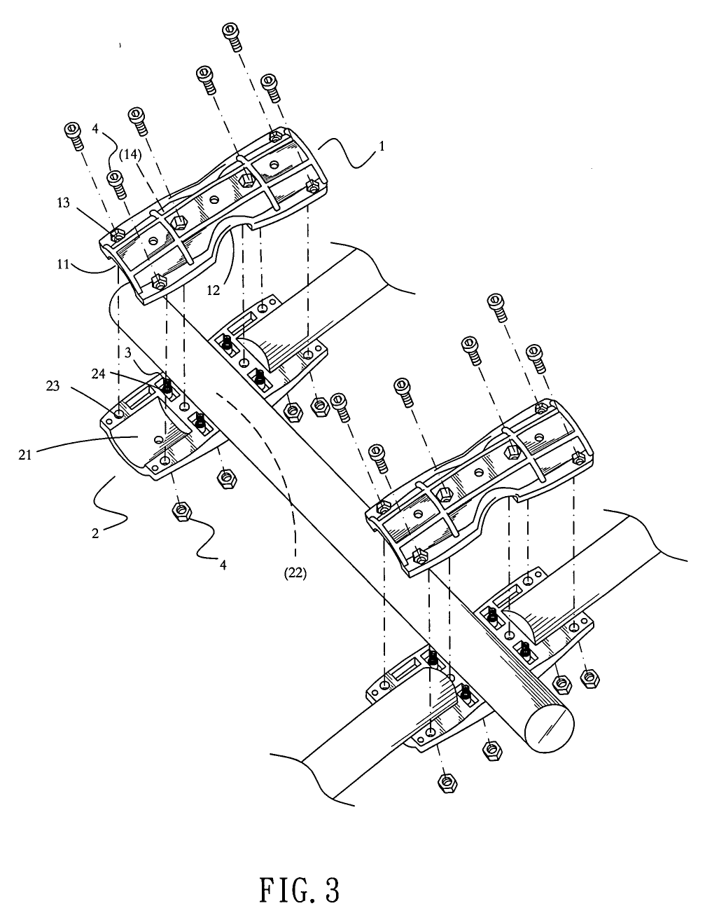

A third preferred embodiment of the present invention as illustrated in FIG. 3 includes a lid (1), a carrier (2), multiple elastic members (3), and multiple fasteners (4). A pair of longitudinal grooves (11) are respectively disposed in symmetry on both ends on one side of the lid (1); a lateral groove (12) is formed between the pair of longitudinal grooves (11); multiple locating holes (13) are respectively disposed on both sides of each longitudinal groove (11) and where between the longitudinal groove (11) and the lateral groove (12) with each locating hole (13) disposed next to it a slot (14) in same construction as that of and spatially corresponding to a secondary slot (24) to be described below.

The carrier (2) incorporated to the lid (1) is disposed with a pair of secondary longitudinal grooves (21), a secondary lateral groove (22), multiple connecting holes (23), and multiple slots (24) correspond to the pair of longitudinal grooves (11), the lateral groove (12), those locating holes (13), and those slots (14) disposed on the lid (1). Those multiple elastic members are respectively received in those slots (14) and secondary slots (24), and the secondary lateral groove (22) spatially corresponds to the lateral groove (12). Those multiple fasteners (4) are respectively inserted into their respective locating holes (13) and connecting holes (23).

Accordingly, assuming that each connector of the third preferred embodiment as illustrated in FIG. 3 has been assembled, it basically functions same as that by the first and the second preferred embodiments and differs in that the pair of the longitudinal grooves (11) of the lid (1) is arranged in symmetry and the pair of the secondary longitudinal grooves (21) on the carrier (2) are also arranged in the same mode.

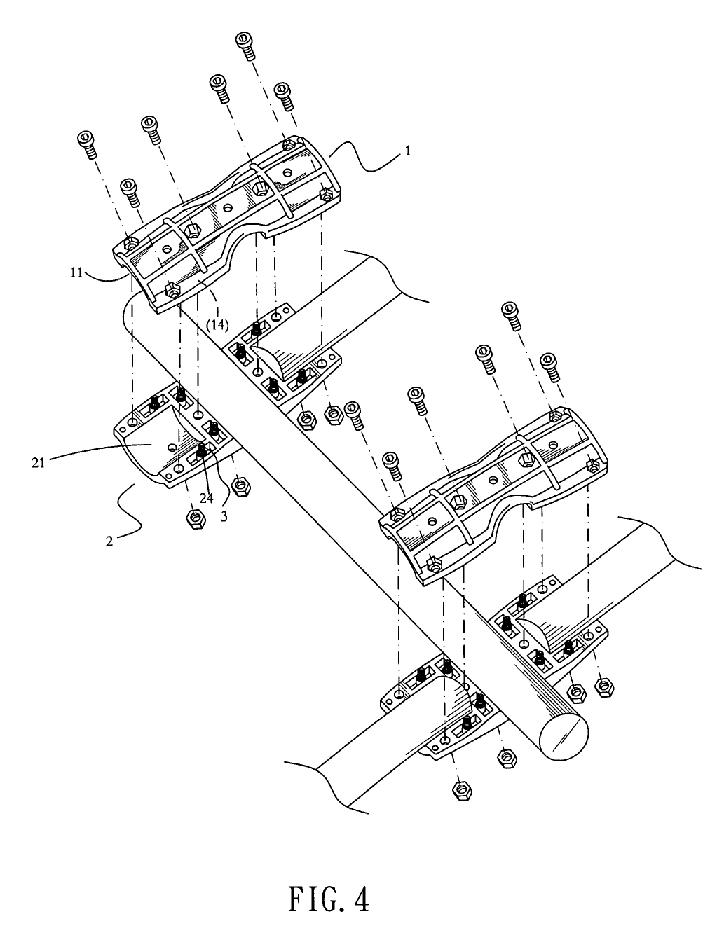

As illustrated in FIG. 4, a fourth preferred embodiment derived form the third preferred embodiment of the present invention, two secondary slots (24) are disposed on both sides of each secondary longitudinal groove (21) and the elastic member (3) is received in each secondary slots (24); similarly, multiple slots (14) in construction same as that of the slot (24) of the carrier (2) are respectively disposed on both sides of the longitudinal groove (11); and both slots (14) (24) receive insertion of the elastic member (3). Accordingly, the fourth preferred embodiment while achieving the same purpose and provide the same functions as those by the third preferred embodiment provides stronger elasticity to hold open both of the lid (1) and the carrier (2).

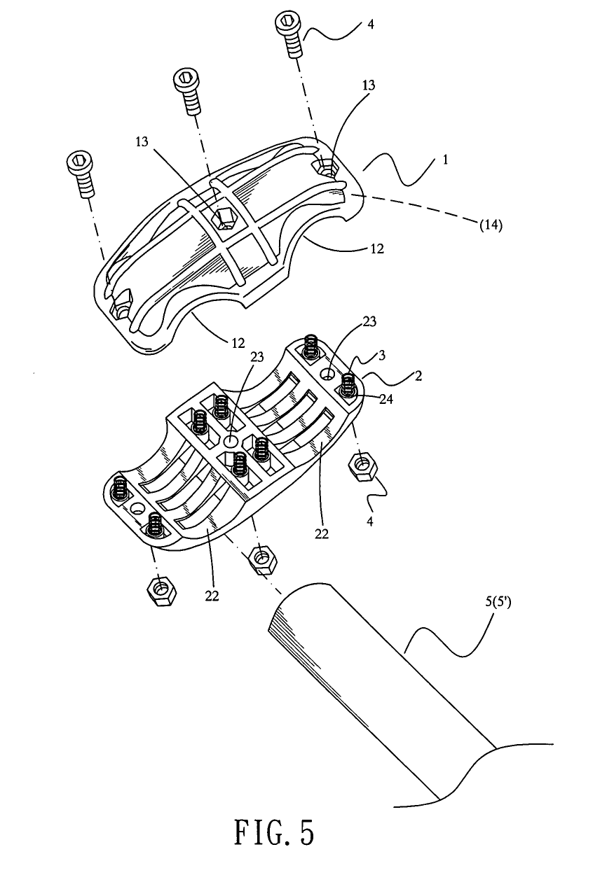

As illustrated in FIG. 5, a fifth preferred embodiment of the present invention includes a lid (1), a carrier (2), multiple elastic members (3), and multiple fasteners (4). The lid (1) has on one side disposed with two lateral grooves (12) separated from each other; one or a plurality of slot (14) and a locating hole (13) are disposed at where between two lateral grooves (12). The slot (14) is made in the same construction as that for a secondary slot (24) to be described below. One or a plurality of slot (14) and a locating hole (13) are disposed on the other side of each of both lateral grooves (12). The carrier (2) incorporated to the lid (1) is disposed of two secondary lateral grooves (22), one or a plurality of secondary slot (24), and a connecting hole (23) respectively corresponding to the pair of lateral grooves (12), the slot (14) or those multiple slots (14), and the locating hole (13) of the lid (1). Those multiple elastic members (3) are respectively received in those slots (14) and secondary slots (24). Those multiple fasteners (4) are inserted into those locating holes (13) and connecting holes (23) respectively from the lid (1) and the carrier (2).

Accordingly, in a fifth preferred embodiment of the present invention as illustrated in FIG. 5, a carrier (2) has disposed between two secondary lateral grooves (22) one or a plurality of secondary slot (24), and multiple elastic members (3) are respectively received in each secondary slot (24) and slot (14). With the elastic member (3) appropriately loosened up in the fastener (4), the lid (1) is raised without being ejected since the fastener (4) remains holding against the locating hole (13) and the connecting hole (23). Similarly, the lid (1) is also designed to such that it corresponds to the carrier for the tube (5) and/or the hollow tube (5′) to be smoothly clamped at where between the lateral groove (12) and the secondary lateral groove (22) without slip and deflection. To remove the tube (5) or the hollow tube (5′), simply reverse the assembly procedure.

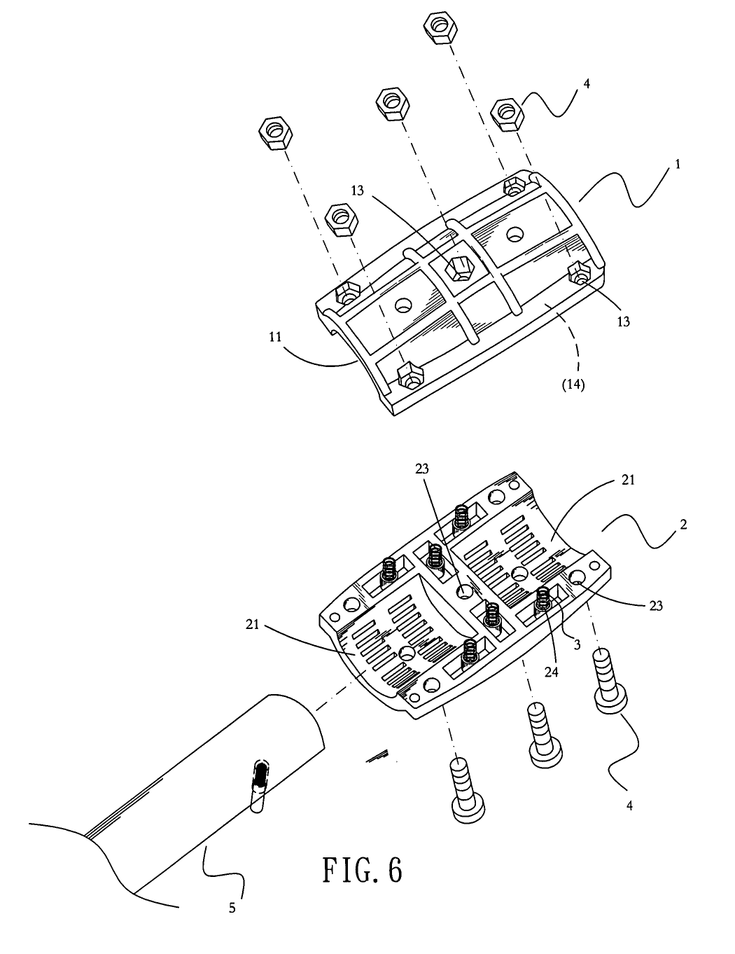

A sixth preferred embodiment of the present invention as illustrated in FIG. 6 is comprised of a lid (1), a carrier (2), multiple elastic members (3), and multiple fasteners (4). Two longitudinal grooves (11) separated from each other are disposed on one side of the lid (1); one or a plurality of slots (14) and a locating hole (13) are disposed at where between both longitudinal grooves (11); multiple slots (14) are each disposed on both sides of each longitudinal groove (11); and a locating hole (13) is disposed next to each slot (14). The carrier (2) incorporated to the lid (1) is disposed with two secondary longitudinal grooves (21), one or a plurality of secondary slots (24) and a connecting hole (23) respectively corresponding to those two longitudinal grooves (11), the slot (14) or those multiple slots (14), and the locating hole (13) on the lid (1). Each elastic member (3) is received in the slot (14) and the secondary slot (24); and each fastener (4) is inserted into the locating hole (13) and the connecting hole (23) respectively of the lid (1) and the carrier (2).

Accordingly, a sixth preferred embodiment as illustrated in FIG. 6 has on both sides of the secondary longitudinal groove (21) each disposed with the secondary slot (24); each secondary slot (24) is inserted with an elastic member (3); similarly, the lid (1) is provided with corresponding design for the elastic member (3) to hold open the lid (1) and the carrier (2) for facilitating insertion of the tube (5) or replacement with the hollow tube (5′) as illustrated in FIG. 8 while the remaining performance of the sixth is similar to that of any of those preferred embodiments already described.

Generally, each of those six preferred embodiments as respectively illustrated in FIGS. 1 through 6 is provided with the same design represented by the first preferred embodiment to be described as follows:

Each of the longitudinal groove (11), the lateral groove (12), the secondary longitudinal slot (21), or the secondary lateral slot (22) is provided with an open end and a closed end. The open end allows insertion of the tube (5) when both of the lid (1) and the carrier (2) are incorporated to each other while the closed end is provided for the tube (5) inserted into the connector to tightly hold against.

Option ally, a limiting hole (15) (25) is disposed in the longitudinal groove (11), the lateral groove (12), the secondary longitudinal groove (21) or the secondary lateral groove (22) to latch the tube (5) when the tube (5) has provided on a surface of its proximate end closer to the connector a through hole (51) and a stud (52) is disposed in the through hole (51) to be inserted into the limiting hole (15) (25).

An elastic object (53) related to a coil or any equivalent object connects the stud (52) and the through hole (51). On the other side each of lid (1) and the carrier (2) is provided with alternatively arranged reinforcement ribs (16) (26). Those reinforcement ribs (16) on the lid (1) are of same design as that for those reinforcement ribs (26) on the carrier (2) to make stronger construction of the connector and help dissipate stress generated when the lid (1) and the carrier (2) are incorporated to each other.

As illustrated in FIG. 7, the stud (52) has one end connected to the elastic object (53) and one end of the elastic object (53) is further connected to the through hole (51) disposed on the surface of the proximate end of the tube (5) closer to the connector. Simply press the stud (52) in the direction of the through hole (51), and the stud (52) causes the elastic object (53) to contract. Once the tube (5) is inserted into the longitudinal and the lateral grooves (11) (12) and/or the secondary longitudinal and the secondary lateral grooves (21)(22), the stud (52) is inserted into the limiting hole (15) (25).

As further illustrated in FIG. 8, the elastic object (53) may be made in a V-shaped coil (A) with its both ends each disposed with a stud (A1) to be respectively inserted into the through hole (51) disposed on the surface of the of the hollow tube (5′) and into the limiting hole (15) (25). That is, the stud (A1) is made insufficient length to achieve it purpose. Therefore, both studs (A1) are slightly pressed to facilitate their insertion into an open end of the hollow tube (5′) with the tip of the V-shaped coil (A) facing the open end of the hollow tube (5′). Once the V-shaped coil (A) enters into the hollow tube (5′) for a certain distance, both studs (A1) are inserted into the through hole (51) disposed on the surface of the hollow tube (5′). Once the end of the hollow tube (5′) is further connected with any of those preferred embodiments, both studs (A1) are inserted into the limiting hole (15) and/or (25) to complete assembly or disassembly of the hollow tube (5′) and the connector.

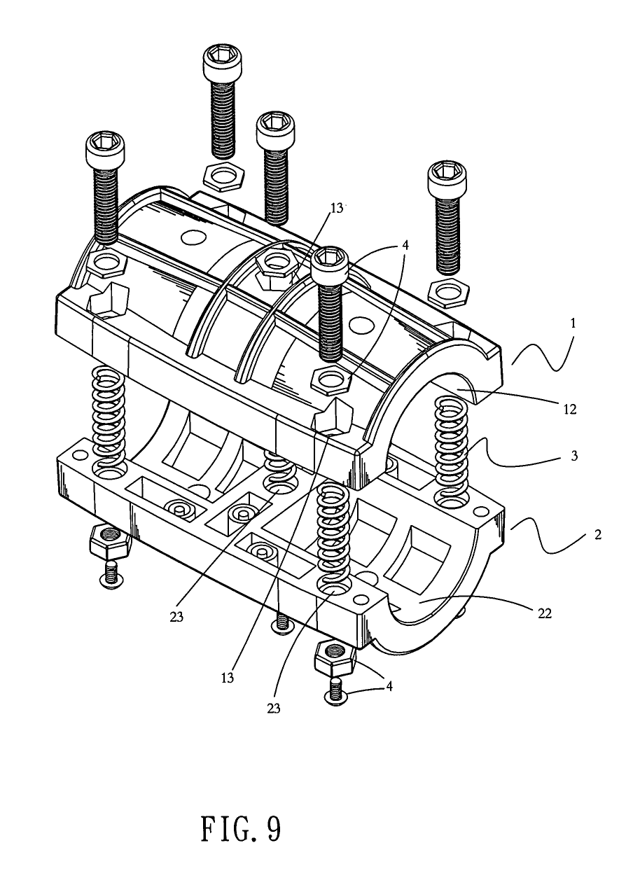

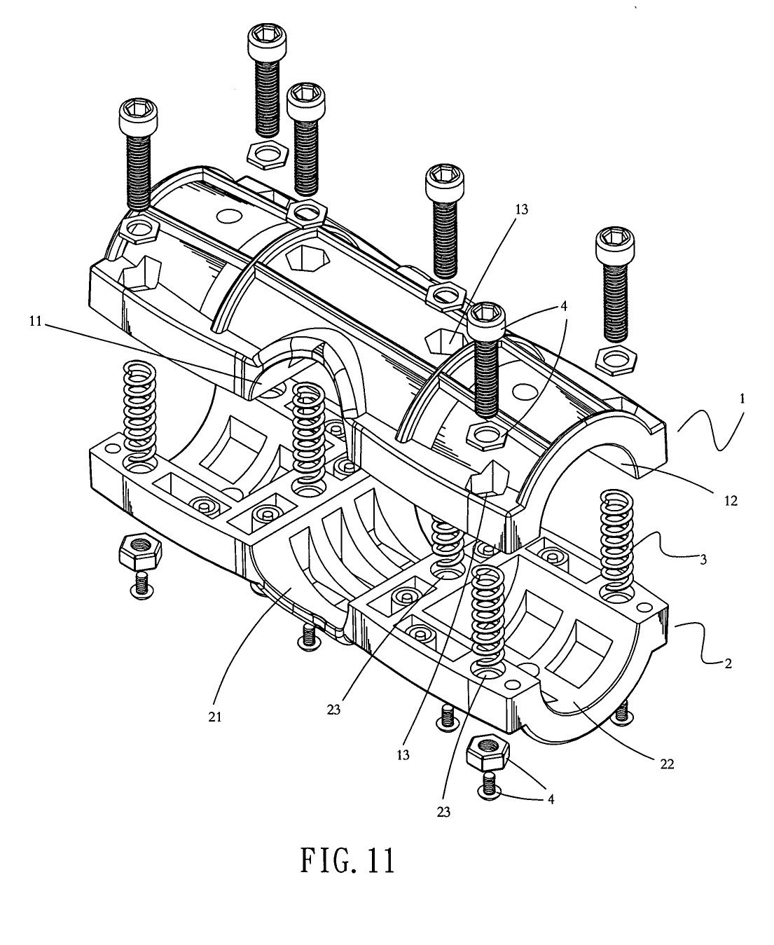

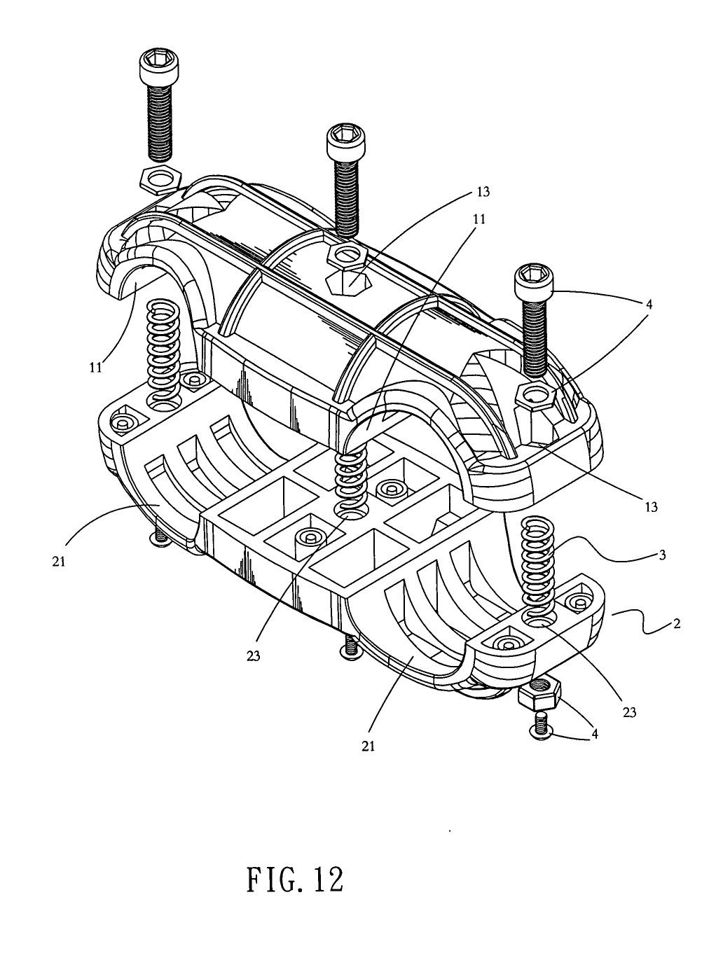

Now referring to FIGS. 9 through 12 respectively showing a seventh, an eighth, a ninth, and a tenth preferred embodiment of the present invention, each preferred embodiment includes a lid (1) having on one side disposed with one or a plurality of locating hole (13) and one or a plurality of longitudinal groove (11) and/or lateral groove (12) disposed next to the locating hole (13); a carrier (2) having on one side disposed with one or a plurality of connecting hole (23) and one or a plurality of the secondary longitudinal groove (21) and/or lateral groove (22) respectively corresponding to those disposed on the lid (1); one or a plurality of the elastic member (3) received in the locating hole (13) and the connecting hole (23); and multiple fasteners (4) are inserted into those locating holes (13) and connecting holes (23) respectively from the lid (1) and the carrier (2).

As illustrated in FIGS. 9 through 12, a space defined by the locating hole (13) and the connecting hole (23) is sufficient to accommodate the elastic member (3) in similar size. The quantity of the elastic member (3) is adjusted as applicable while the design and functions of those preferred embodiments illustrated in FIGS. 9 through 12 are the same as those preferred embodiments illustrated in FIGS. 1 through 6 in achieving easy and fast mounting or removing of tube to or from the connector.

The prevent invention provides an improved structure of a tube rack connector, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

1. A tube rack connector includes a lid, a carrier, multiple elastic members, and multiple fasteners; the lid having on one side disposed with a longitudinal groove, a lateral groove disposed next to the longitudinal groove, multiple locating holes each disposed to both sides of the longitudinal groove and at where between one end of the lateral groove and the longitudinal groove and the lateral groove respectively, and a slot disposed next to the longitudinal groove and/or the lateral groove; the carrier incorporated to the lid having on one side respectively disposed with a secondary longitudinal groove and a secondary lateral groove corresponding to the longitudinal and the lateral grooves on the lid, a locating hole disposed corresponding to that disposed on the lid, a secondary slot corresponding to the slot on the lid disposed next to the secondary longitudinal groove and/or the secondary lateral groove; multiple elastic members being respectively disposed in those slots and secondary slots; and multiple fasteners being each disposed in the locating hole and the connecting hole respectively from the lid and the carrier.

2. A tube rack connector includes a lid having provided on both ends on one side a pair of longitudinal grooves arranged in symmetry, a lateral groove disposed between those two longitudinal grooves, multiple locating holes each disposed on both sides of each longitudinal groove and at where between each longitudinal groove and the lateral groove, and multiple slots each disposed on both sides of each longitudinal groove and/or at where between each longitudinal groove and the lateral groove; a carrier incorporated to the lid being disposed of two secondary longitudinal grooves, a secondary lateral groove, multiple connecting holes and multiple secondary slots respectively corresponding to those longitudinal grooves, lateral groove, locating holes and slots on the lid; multiple elastic members each received in those slots and secondary slots; and multiple fasteners each inserted into the locating hole and the connecting hole respectively from the lid and the carrier.

3. A tube rack connector includes a lid having provided on one side a pair of lateral grooves separated from each other, multiple locating holes each disposed on both sides of each lateral groove and on the other side of each lateral groove, and multiple slots each disposed on both sides of each longitudinal groove and/or at where between each longitudinal groove and the lateral groove; a carrier incorporated to the lid being disposed of two secondary lateral grooves, one or a plurality of secondary slots, and multiple connecting holes respectively corresponding to those two lateral grooves, one or a plurality of slot, and multiple locating holes on the lid; multiple elastic members each received in those slots and secondary slots; and multiple fasteners each inserted into the locating hole and the connecting hole respectively from the lid and the carrier.

4. A tube rack connector includes a lid having provided on one side a pair of longitudinal grooves separated form each other, multiple locating holes each disposed on both sides of each longitudinal groove and at where between two longitudinal groove, and multiple slots each disposed on both sides of each longitudinal groove and/or at where between two longitudinal grooves; a carrier incorporated to the lid being disposed of two secondary longitudinal grooves, multiple secondary slots, and multiple connecting holes respectively corresponding to those longitudinal grooves, slots and locating holes on the lid; multiple elastic members each received in those slots and secondary slots; and multiple fasteners each inserted into the locating hole and the connecting hole respectively from the lid and the carrier.

5. A tube rack connector includes a lid having disposed on one side one or a plurality of locating hole, and one or a plurality of longitudinal groove and/or one or a plurality of lateral groove; a carrier having disposed on one side one or a plurality of connecting hole, one or a plurality of secondary groove and/or one or a plurality of secondary lateral groove respectively corresponding to the locating hole, longitudinal groove and/or lateral groove on the lid; one or a plurality of elastic member received in the locating hole and connecting hole; and multiple fasteners each inserted into the locating hole and the connecting hole respectively from the lid and the carrier.

6. The tube rack connector as claimed in claim 1, wherein multiple limiting holes are each disposed on the inner edge surface of the longitudinal and the lateral grooves.

7. The tube rack connectors as claimed in claim 1, wherein on the other side each of the lid and the carrier is disposed with multiple reinforcement ribs alternatively arranged.

8. The tube rack connector as claimed in claim 1, wherein the limiting hole is provided to latch the tube.

9. The tube rack connector is claimed in claim 8, wherein a stud is disposed in a through hole on a surface at the proximate end of the tube closer to the connector; the stud is inserted into the limiting hole; and an elastic object connects the stud and the groove.

10. The tube rack connector as claimed in claim 9, wherein the elastic object relates to a V-shaped coil with both ends each disposed with a stud to be respectively inserted into the through hole on a hollow tube and the limiting hole.
